(19) United States
(12) Patent Application Publication
(10) Pub. No.: US 2004/0097109 A1
(43) Pub. Date: May 20, 2004

(54) Connector and method of mounting

(76) Inventor: Alexander Mayer, Brunswick (AU)

Correspondence Address: Don D Cha, Townsend & Townsend & Crew, 8th Floor, Two Embarcadero Center, San Francisco, CA, 94111-3834, US

(21) Appl. No.: 10/451,203

(22) PCT Filed: Dec. 18, 2001
(86) PCT No.: PCT/AU01/01634

(30) Foreign Application Priority Data
Dec. 18, 2000 (AU) PR 2153

(51) Int. Cl. H01R 12/00

(52) U.S. Cl. 439/84

(57) ABSTRACT

There is provided a connector for mounting on a printed circuit board (5), the connector including at least two mechanically balanced pick-up points (23,25). The pick-up points (23,25) may be marked to indicate their position. Typically the connector is an angled connector. There is also provided a method for mounting a connector of the invention, the method typically including the steps of: a) attaching a pick-up device to a pick-up point of the connector, b) lifting the connector using the pick-up device, c) placing the one or more tabs (1a, 1b, 1c, 1d) of the connector into contact with adhesive means located on the circuit board, d) disengaging the pick-up device from the angled connector, e) heating the circuit board to (5) liquefy the adhesive means and allowing the angled connector to self centre, and subsequently f) allowing the adhesive means to re-solidify so that the tabs (1a, 1b, 1c, 1d) are held in electrical contact with the circuit board (5).

### FIELD OF THE INVENTION

The present invention relates to a connector and method of mounting the connector on a circuit board, the connector having a mechanically balanced pick-up point. In particular the present invention relates to an angled connector having a mechanically balanced pick-up point and method of mounting the angled connector on a circuit board.

### BACKGROUND OF THE INVENTION

The invention will be further described with reference to angled blade connectors that is, connectors other than straight pin or straight blade connectors, however it will be readily apparent to those skilled in the relevant technology that other types of connectors, such as screw connectors, female connectors, multi-pin connectors and other devices for making electrical contact are encompassed within the scope of the invention.

Furthermore, where a document, act or item of knowledge is referred to or discussed, this reference or discussion is not an admission that the document, act or item of knowledge or any combination thereof was at the priority date either part of the common general knowledge, or known to be relevant to an attempt to solve any problem with which this specification is concerned.

Circuit boards comprise an electric circuit having wiring connections incorporated in a board. They are extensively used and can be found in an enormous number of electronic apparatus. Circuit boards are designed to carry a vast number of components including angled connectors to facilitate electrical contact between the circuit and other devices. Connectors are commonly in the form of straight elongate pins or rectangular blade-like projections, one end of which is maintained in electrical connection with the circuit board. The other, free end of the connector can be attached to an input, wiring harness or plug of another board or another device.

The act of attaching the input or device requires application of force, thus putting stress on the area of attachment between the connector and the circuit board. This is a particular problem when the connector is surface mounted, that is, held to the surface of a circuit board by a small portion of solder or the like. For example, in order to attach an input or plug, to a straight pin or blade connector, force is applied along the longitudinal axis of the pin or blade, perpendicular to the plane of the circuit board. Force applied off the normal puts stress on the solder connection, and can cause it to break with the result that the connector detaches from the circuit board. This problem is exacerbated with angled connectors because the force applied to the free end of an angled connector usually causes a rotational moment to be applied to the connector about its base, thus levering the angled connector, potentially breaking it off where it attaches to the circuit board.

Another problem with connectors, particularly angled surface mounted connectors, is their inherent instability when being placed on the circuit board. Angled connectors in particular, may have a mass distribution around the angled portion which causes the angled connector to tip if not positively supported. This means that care needs to be taken as to how angled surface mounted connectors are kept in position on the circuit board prior to soldering.

Connectors are mass production items and are provided in a form convenient for supply to a pick-up machine for mounting connectors on a circuit board. For example, connectors may be produced in a continuous strip, each connector attached to adjacent connectors by tabs. Alternatively, individual connectors may be carried on a plastic strip. The strip may have an adhesive on one or both sides to which the connectors adhere. In another alternative, connectors are located in pockets along the length of a plastic strip carrier.

Different pick and place feeders use different forms of connector supply. U.S. Pat. No. 5,449,265 and U.S. Pat. No. 5,605,430 describe a process wherein a continuous strip of connectors joined by tabs is fed from a reel through a feeder, which progressively shears the connecting tab of the end connector to thus individually dispense each connector to the correct position for a ‘pick and place’ device that picks up individual connectors and places them on a circuit board. Other types of pick and place devices have a vibratory bowl hopper for loose pre-cut connectors, the vibrating bowl delivering terminals oriented in the correct position, to a feeder of a pick-up and place device. Connectors carried on a plastic strip are separated by peeling, winding or cutting away the tape at the feeder which supplies the pick-up and place device.

There are numerous techniques for mounting surface mounted connectors on a circuit board. For example, one well known technique relies on each connector having a ‘pick-up-post’ which is a post that fits in a correspondingly shaped nozzle of a vacuum pick-up device. When vacuum is applied, the component can be picked up and moved to a predetermined location on a circuit board. The pick-up device then lowers the component onto a small amount of solder paste on the board, that holds it in position. The vacuum can then be removed and the vacuum pick-up device disengaged from the connector. The board is heated to melt the solder, then cooled so that the solder solidifies about the base of the male connector, thus holding the component in place.

However, this system is designed for affixing straight types of connectors to a circuit board and is not readily adapted to affix angled connectors. Furthermore, often a pick-up and place device may not pick up and place connectors in the correct orientation or the connector may move before placement on the circuit board. For example, optionally pin or blade connectors will be placed on the circuit board such that the pin or blade is precisely perpendicular to the board.

It has now been found that an improved connector and method of attachment to a circuit board can be provided, such that the connector is easier to mount, and is less likely to detach from the board when subject to normal forces such as the attachment of another device to the circuit board. In particular a new angled connector and method of attachment have been found.

### SUMMARY OF THE INVENTION

In a first aspect, the invention relates to connectors for surface mounting on a printed circuit board, the connectors having two or more mechanically balanced pick-up points at which they can be picked up and placed on a printed circuit board.

In a second aspect of the present invention, the position of the pick-up point is flagged by an indicator, preferably a visual indicator such as a coloured mark or some other distinct physical feature although other types of indicators such as magnets are envisaged as falling within the scope of the present invention. The indicator may, for example, be able to be readily removed from the connector, or it may be integral with the connector. The indicator may be designed to physically facilitate pick up of a connector at the pick-up point. Alternatively it may merely flag the location of the mechanically balanced pick-up point without facilitating pick up.

Depending on its shape, a connector may have one or more mechanically balanced pick-up points. Typically the connector has two or more mechanically balanced pick-up points.

The connector may include a conveniently configured pick-up means included at the pick-up point. The pick-up means may be of any convenient configuration and will vary depending on the nature of the pick-up device. For example the pick-up means may consist of a projection or recess or a hole through the connector which can be engaged by a pick-up-device. Typically the mechanically balanced pick-up points comprise a post shaped to fit in the correspondingly shaped vacuum nozzle of a pick-up device of the type described above. Typically these may be formed by a pair of spaced slots in the connector which define the post.

‘Mechanically balanced’ when used in this specification means that a pick-up point is located substantially at a point constituted by a vertical plane running through the center of gravity of the connector such that when the connector is picked up by the pick-up point the mass is evenly distributed about the pick-up point.

Use of a mechanically balanced pick-up point ensures that connectors are picked up in a consistent manner and placed on a circuit board in a consistent manner.

Specifically, it is important that the connector remains level so as to contact the printed circuit board and remain correctly balanced. The less the thickness of solder between the circuit board, the stronger the bond.

In a third aspect of the present invention the connector is an angled connector, having a pick-up point. Preferably the angled connector has one or more tabs for electrical contact with the circuit board on which the angled connector can stand. Accordingly this embodiment of the angled connector does not need to be held in position by auxiliary means, prior to, or during attachment to the circuit board. In a particularly preferred embodiment, the angled connector is sufficiently balanced that it can be lowered onto the horizontal surface of a circuit board, and stand on the one or more tabs without falling over. In a particularly preferred embodiment, there is an identical thickness of solder between the one or more tabs of the connector and the circuit board resulting in a uniformly strong bond.

According to another form of the invention there is provided an angled connector for mounting on a printed circuit board, the angled connector being adapted to be picked up at a mechanically balanced pick-up point. In a forth aspect of the present invention, the connector is an angled connector having two or more mechanically balance pick-up points. It is particularly preferred that the angled connector for mounting on a printed circuit board has,

a contact, and

a base including one or more tabs defining a plane and suitable for attachment to a conductive surface of a printed circuit board.

Preferably the connector is an angled connector for surface mounting on a printed circuit board.

In addition the angled connector may include,

a contact having,

(i) a first portion projecting from the base in a first direction and

(ii) a second portion projecting in a second direction from the first portion, the second portion being adapted to receive a connector or other device applied in a direction parallel to the second direction, the first direction differing from the second direction.

Typically, the angled connector has a first mechanically balance pick-up point located on the first or second portion of the contact. Optionally, a second mechanically balanced pick-up point may be located on the base.

In a preferred embodiment the pick-up-means located at the mechanically balanced pick-up points are in the form of posts. It is particularly preferred that the posts are formed in the first or second portions of the contact.

In a preferred embodiment, the base of the angled connector is elongated or broadened as a further counter to the length or mass of the first and second portions. Such a base provides the angled connector with increased stability when attached to the circuit board and decreases the possibility of the angled connector detaching from the board if force is applied of the angled connector. Further to this, the one or more tabs may be arranged along the base in a manner that maximises the distribution of any force applied to the angled connector after it is attached to the circuit board.

Each tab may be adapted to promote capillary action of molten solder and improve adhesion of the connector to the circuit board and minimise connector movement during solder re-flow. For example, one or more tabs may be adapted to include an open slot along its surface that in use, rests adjacent the circuit board. Alternatively the tab may be shaped to include recesses. The open slot or recesses provide for capillary action of molten solder and maximises the surface contact between the tab and the solder as compared with a flat, featureless rectangular tab of the prior art. This enhances the strength of attachment of the angled connector to the solder, and concomitantly, the strength of attachment of the angled connector to the circuit board.

With respect to the conformation of the angled connector, the first direction preferably forms an included angle of between 5 and 175° with the second direction. More preferably, the included angle is 45 to 95°. In a particularly preferred embodiment the contact is L-shaped, the first direction being perpendicular to the second direction.

The first portion may project from the base at any convenient angle. Preferably the first direction forms an included angle of between 5 and 90° with the plane defined by the tabs of the base but more preferably, the included angle is about 90°.

The first portion and second portion may be of any suitable shape or conformation including posts, pins or flat strips or tabs. Typically, the first portion and second portion are integral. In a particularly preferred embodiment the first portion and the second portion are tabs of generally rectangular shape.

The contact may be of any convenient thickness, but preferably the first and second portions are 0.5 mm, 0.8 mm or any non-standard thickness.

Preferably the connectors of the present application are made from conductive material such as metal, and may be electroplated. Typically the connectors are brass, electroplated with tin.

Preferably, a single production run produces multiple angled connectors according to the invention, each directly or indirectly attached to one or more other connectors. For example, with reference to the angled connectors, these may be produced in a strip, each angled connector being attached by a frangible web to the angled connectors on either side. Alternatively, the angled connectors may be produced in a sheet, each angled connector having at least one frangible web attaching it to adjacent angled connectors.

In another particularly preferred embodiment, the multiple angled connector of the present invention can be produced by a single pressing of a sheet metal.

The present invention also provides a method for mounting a connector having two mechanically balanced pick-up points on a circuit board. The method includes the steps of;

(a) placing the connector in a predetermined position relative to the circuit board; and

(b) attaching the connector so that it is in electrical contact with the circuit board.

Preferably the connector is an angled connector having two mechanically balanced pick-up points. The connector may be attached by any convenient means including solder, weld or electrically conductive glue.

According to a preferred embodiment, the method for mounting a connector having two mechanically balanced pick-up points, and one or more tabs on a circuit board, includes the steps of;

(a) attaching a pick-up device to a pick-up point of the connector,

(b) lifting the connector using the pick-up device,

(c) placing the one or more tabs of the connector into contact with adhesive means located on the circuit board,

(d) disengaging the pick-up device from the angled connector,

(e) heating the circuit board to liquify the adhesive means and allowing the angled connector to self centre, and subsequently

(f) allowing the adhesive means to re-solidify so that the tabs are held in electrical contact with the circuit board.

Step (d) may be prior or subsequent to either steps (e) or (f). Preferably the connector is sufficiently balanced that it can stand on the one or more tabs without falling over so that step (d) can occurs before step (e) or (f).

Typically the adhesive means is solder or solder paste. Physical effects, such as the effect of surface tension, cause the connector to self centre when in contact with the liquid adhesive means.

The above method may further comprise the step of locating the connector at least partly within a recess in the circuit board. This step of the method allows much greater stability and strength in the mounting of the connector to the circuit board holding the connector to resist it being detached from the mounting board by the application of force to the free end.

Typically the recess is a slot through the circuit board. The recess may be of any convenient shape, size and location on the board depending on the method of mounting.

The method of mounting of the present invention encompasses the steps of locating a connector having two mechanically balanced pick-up points and at least one tab in position on a circuit board, the method including the step of passing at least part of the connector through a recess in the board.

Alternatively when the recess is a slot, having one end located at an edge of the circuit board, at least part of the connector may be slid along the slot to the desired final position.

According to a particularly preferred embodiment of the mounting method of the present invention, the contact of the angled connector passes through and extends from a slot-like recess such that the tabs are located on one side of the circuit board and at least part of the connector is located on the other side of the circuit board. When the connector is an angled connector, preferably the one or more tabs are located on one side of the circuit board and the contact is located on the other side. According to another preferred embodiment of the method of the present invention, one of the two mechanically balanced pick-up points on the connector is an elongated post that can be located in a small recess formed in the circuit board so that the second pick-up point is located on one side of the circuit board and at least part of the connector is located on the other side. Where the connector is an angled connector, the second pick-up point can be an elongated post located on one side of the circuit board while the contact is located on the other side. The one or more tabs may be located on either side of the circuit board as convenient. In these configurations, the second pick-up point may thus be used as a test point for a suitable electrically based instrument probe.

According to yet another preferred embodiment of the method of the present invention, the connector is inserted in, dropped through, or slid along a slot-like recess having one end located at an edge of the circuit board. This method can be used to locate the tabs and contact on opposite sides of the circuit board.

### DESCRIPTION OF THE DRAWINGS

The invention will now be further described with reference to the following drawings in which;

FIG. 1 is a perspective drawing of one embodiment of an angled connector of the present invention mounted on a surface of a circuit board;

FIG. 2 is a perspective drawing of the angled connector of FIG. 1 which has been passed through a slot-like recess to be mounted on the circuit board; and

FIG. 3 is a perspective drawing of a further embodiment of the angled connector of the present invention which has been slid or passed into its mounted position through a slot-like recess having an end located at one edge of a circuit board.

FIG. 4 is a drawing of a further embodiment of an angled connector of the present invention.

FIG. 5 is a drawing of a strip of connectors, each connector having the configuration of the connector of FIG. 4.

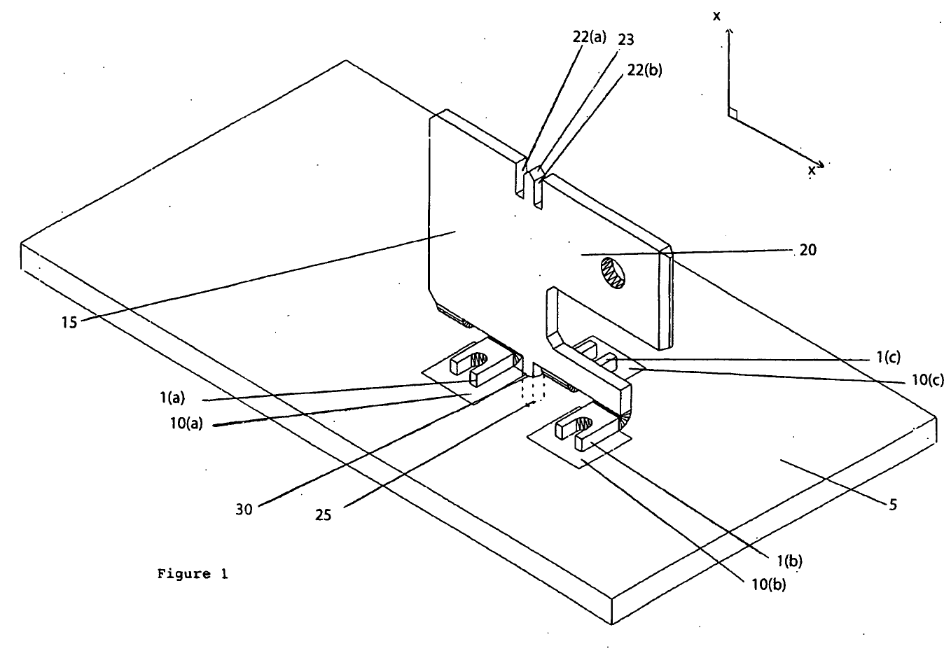

In order to better show the position of the angled connector relative to the circuit board in FIGS. 1 to 3, broken lines have been used to depict the parts of the angled connector below the plane of the circuit board, and unbroken lines have been used to depict the parts of the angled connector above the plane of the circuit board.

FIG. 1 shows one embodiment of an angled connector of the present invention which has been surface mounted on a circuit board. The angled connector has a base which includes four tabs (1(a), 1(b), 1(c), 1(d)) which define a plane and rest on the flat surface of a circuit board (5). Each tab is seated on a corresponding spot of solder (10(a), 10(b), 10(c), 10(d)) which hold the tabs in position and maintain electrical contact between the tabs and the circuit. The entire base portion of the angled connector is elongate, thus maximising the area of the angled connector attached to the circuit board, and maximising the distribution of any force or stress applied to the attachment.

The angled connector has an L-shaped contact having a first portion (15) projecting from the base in the x-direction (as defined by the axes shown) and perpendicular to the plane defined by the tabs, and an integral, coplanar second portion (20) projecting from the first portion in the y-direction. The base also projects from the first portion in the x-direction. In use, an input, plug or other device would be applied to the second portion in a direction parallel to the second direction, and parallel to the plane of the circuit board. The first portion also includes a pair of spaced slots (22(a), 22(b)) which define a first pick-up point (23) suitable to be received within a vacuum nozzle of surface mounting equipment to facilitate location of the conductor in place on a circuit board. The pick-up point is located at a center of gravity of the angled connector.

The angled connector also has a second pick-up point (25) which is coplanar with the L-shaped contact, and projects from the base in the opposite direction. The second pick-up point is located in a small recess (30) in the circuit board and thus can be used as a test point for in instrument probe.

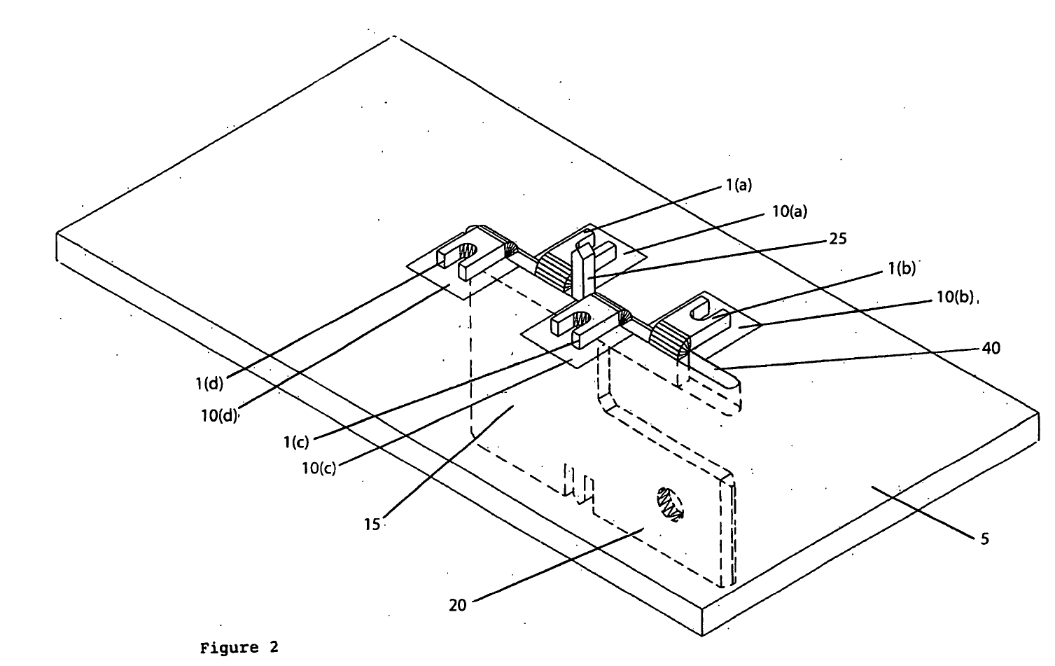

FIG. 2 shows the angled connector of FIG. 1 which has been mounted in a different manner on the circuit board (5). A pick-up device of a mounting system has been used to pick up the angled connector by the second pick-up point, and lowered the first portion (15) and the second portion (20) of the L-shaped contact through a slot-like recess (40). The tabs (1(a), 1((b), 1(c), 1(d)) remain on the upper side of the board, held in electrical contact with the board by solder (10(a), 10(b), 10(c), 10(d)).

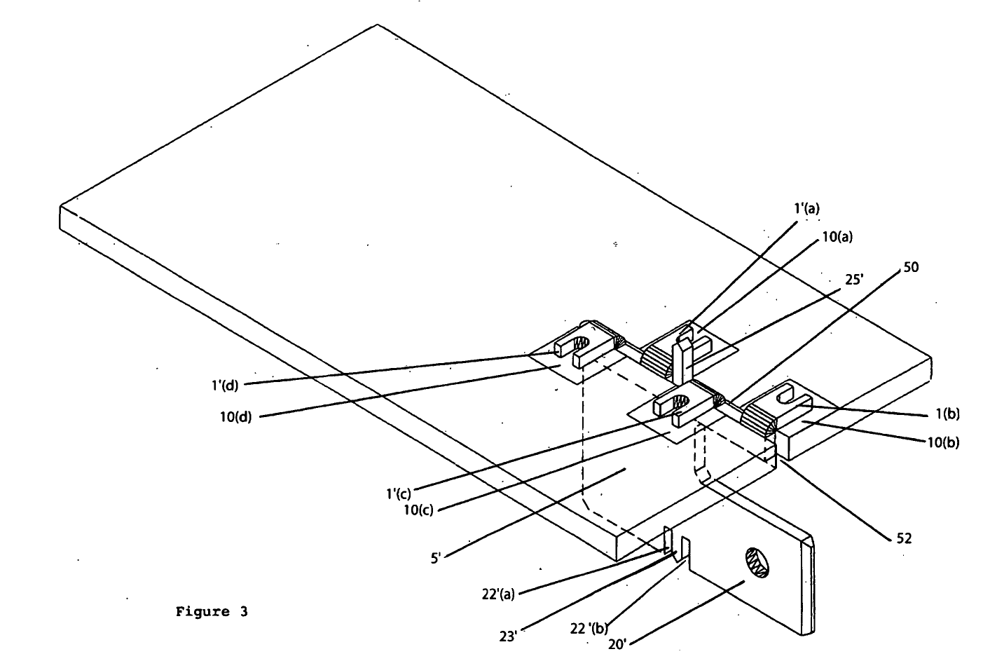

FIG. 3 shows another embodiment of the angled connector which has been mounted using a further embodiment of the method of the present invention. The angled connector of FIG. 1 is similar to the angled connector of FIG. 3 except that the second portion of the latter is longer and projects beyond the base. Again, a pick-up device of a mounting system has been used to pick up the angled connector by the second pick-up point and lower the first portion (15′) and the second portion (20′) into a slot-like recess (50), one end of which (52) is at an edge of a circuit board (5). The tabs (1′(a), 1′(b), 1′(c), 1′(d)) remain on the upper side of the board, held in electrical contact with the board by solder (10(a), 10(b), 10(c), 10(d)). Furthermore, the second portion (20′) overhangs the edge of the circuit board so that in use it may (for example) protrude through an aperture in an adjacent equipment enclosure. If force is exerted on the free end of the angled connector overhanging the board, the provision of an elongated base and location of the tabs on the opposite side of the board assist in distributing any force. The angled connector is thus less likely to detach from the circuit board as compared with angled connectors of the prior art.

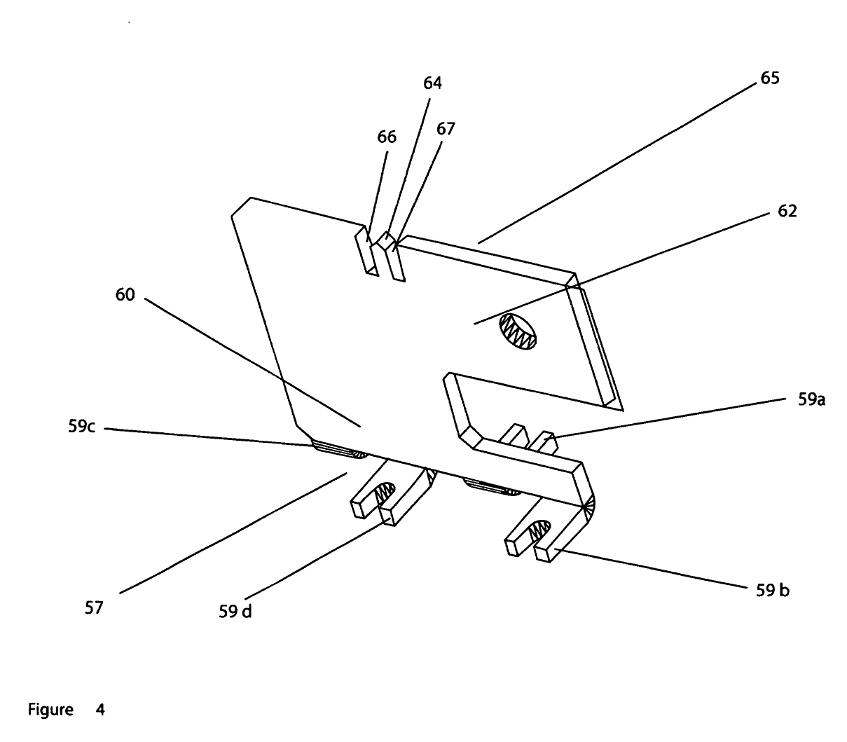

FIG. 4 is a drawing of a further embodiment of an angled connector of the present invention. The drawing clearly shows the contact (55), and the base (57) of the connector which includes tabs (59(a), 59(b), 59(c), 59(d)) defining a plane and suitable for attachment to a conductive surface of a printed circuit board. The contact has a first portion (60) projecting from the base in a first direction and a second portion (62) projecting in a second direction from the first portion. The second portion is adapted to receive a connector or other device applied in a direction parallel to the second direction. In this embodiment the first direction is at right angles to the second direction, thus providing a generally L-shaped contact. A mechanically balanced pick-up point is located on the second portion. A pick-up means in the form of a post (64) is located at the mechanically balanced pick-up point, the post being defined by two slots (66,67) in the contact.

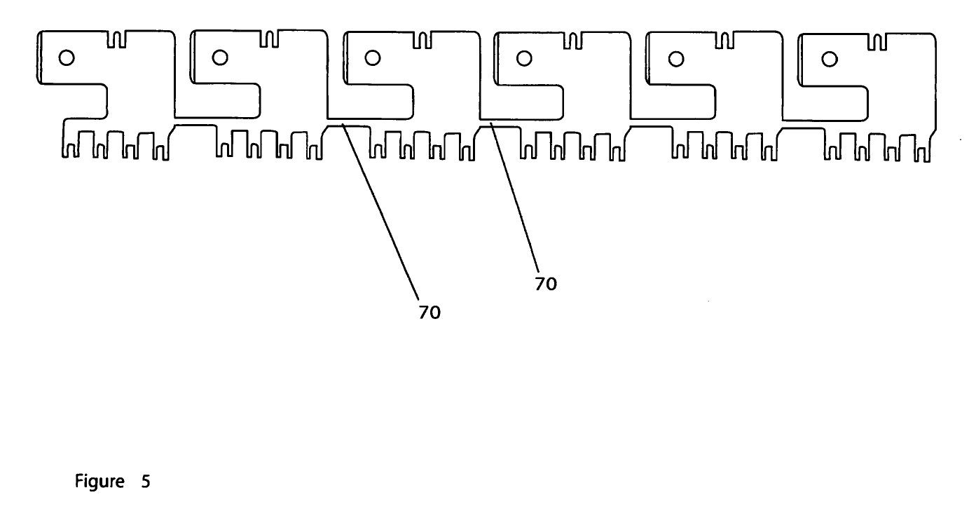

FIG. 5 shows the connector of FIG. 4, manufactured as a strip. Each connector is separated from adjacent connectors by a frangible strip (70).

The word ‘comprising’ and forms of the word ‘comprising’ as used in this description and in the claims does not limit the invention claimed to exclude any variants or additions. Modifications and improvements to the invention will be readily apparent to those skilled in the art. Such modifications and improvements are intended to be within the scope of this invention.

The claims defining the invention are as follows:

1. A connector for mounting on a printed circuit board, the connector including at least two mechanically balanced pick-up points.

2. A connector for mounting on a printed circuit board, the connector including at least two mechanically balanced pick-up points and wherein the connector is an angled connector.

3. A connector according to claim 1 or claim 2 wherein at least one of the pick-up points includes a pick-up means independently chosen from the group consisting of a projection, recess or hole.

4 A connector according to claim 3 wherein the pick-up means is a projection consisting of a post shaped to fit in the correspondingly shaped vacuum nozzle orifice of a pick-up device.

5. A connector according to any one of the preceding claims having;
a contact, and
a base including one or more tabs defining a plane and suitable for attachment to a conductive surface of a printed circuit board,
wherein at least one of the mechanically balanced pick-up points is located on the base.

6. A connector according to any one of claims 2 to 4 which includes,
a base including one or more tabs defining a plane and suitable for attachment to a conductive surface of a printed circuit board, and
a contact having,
(i) a first portion projecting from the base in a first direction and
(ii) a second portion projecting in a second direction from the first portion, the second portion being adapted to receive a connector or other device applied in a direction parallel to the second direction, the first direction differing from the second direction,
wherein a mechanically balanced pick-up point is located on the first or second portion.

7. A connector according to claim 6 wherein a second mechanically balanced pick-up point is located on the base.

8. A connector according to claim 6 wherein the included angle is 5 to 175°.

9. A connector according to claim 8 wherein the first direction being perpendicular to the second direction.

10. A connector according to claim 6 wherein the first direction forms an included angle of between 5 and 90° with the plane defined by the tabs of the base.

11. A connector according to claim 10 wherein the included angle is 90°.

12. A connector according to claim 11 wherein the mechanically balanced pick-up points include pick-up means in the form of posts.

13. A connector according to any one of claims 6 to 12 wherein the base of the angled connector is elongated or broadened relative to the first and second portions.

14. A connector according to any one of claims 5 to 13 having at least one tab adapted to promote capillary action of the adhesive for adhering the connector to a circuit board.

15. A connector according to any one of the preceding claims wherein the connector is manufactured as one of a strip of connectors, each connector in the strip being attached by a frangible means to the connectors on either side.

16. A connector according to any one of claims 1 to 14 wherein the connector is manufactured as one of a sheet of connectors, each connector having at least one frangible means attaching it to adjacent connectors.

17. A connector according to any one of claims 5 to 14 wherein the connector is sufficiently balanced that it can stand unaided on the one or more tabs

18. A method for mounting the connector of any one of the preceding claims the method including the steps of;
(a) placing the connector in a predetermined position relative to a circuit board; and
(b) attaching the connector so that it is in electrical contact with the circuit board.

19. A method for mounting a connector according to any one of 1 to 18, the method including the steps of,
(a) attaching a pick-up device to a pick-up point of the connector,
(b) lifting the connector using the pick-up device,
(c) placing the one or more tabs of the connector into contact with adhesive means located on the circuit board,
(d) disengaging the pick-up device from the angled connector,
(e) heating the circuit board to liquify the adhesive means and allowing the angled connector to self centre, and subsequently
(f) allowing the adhesive means to re-solidify so that the tabs are held in electrical contact with the circuit board.

20. A method according to claim 19 wherein the connector is sufficiently balanced that it can stand unaided on the one or more tabs such that the disengagement step (d) can occur prior to steps (e) or (f).

21. A method according to claim 19 wherein step (d) occurs after step (e) but prior to step (f).

22. A method according to claims claim 18 or 19 which further includes the step of locating the connector at least partly within a recess in the circuit board.

23. A method according to claim 22 wherein the recess is a slot having one end at an edge of the circuit board, and the method includes the step of sliding the connector along the recess.

24. A connector mounted according to the method of any one of claims 18 to 23 wherein the connector includes a contact, base and tabs, and the tabs are located on one side of the circuit board and at least part of the connector is located on the other side of the circuit board.

25. A connector mounted according to the method of any one of claims 18 to 24 wherein the connector is an angled connector and one or more tabs are located on one side of the circuit board and the contact is located on the other side.

26. A connector mounted according to the method of any one of claims 18 to 25 wherein a pick up means in the form of a post is located at each of the two mechanically balanced pick-up points of the connector, one of the posts being located in a small recess formed in the circuit board.

27. A connector according to claim 26 wherein the connector is an angled connector, having a post located on one side of the circuit board while the contact is located on the other side.

28. A connector according to claim 27 wherein the post used as a test point for a suitable electrically based instrument probe.

29. A connector for mounting on a printed circuit board, the connector including one or more indicators indicating the location of one or more mechanically balanced pick-up points.

30. A connector according to claim 29 wherein the indicator is removable.

31. A connector according to claim 29 which further includes,
a contact, and
a base having one or more tabs defining a plane and suitable for attachment to a conductive surface of a printed circuit board.

32. A connector according to claim 31 wherein the at least one tab includes a recess or slot for promoting capilliary action.

33. A connector according to claims 29 or 30 which includes,
a base having one or more tabs defining a plane and suitable for attachment to a conductive surface of a printed circuit board, and
a contact having,
(i) a first portion projecting from the base in a first direction and
(ii) a second portion projecting in a second direction from the first portion, the second portion being adapted to receive a connector or other device applied in a direction parallel to the second direction, the first direction differing from the second direction,
wherein at least one of the mechanically balanced pick-up points is located on the first or second portion.

34. A connector according to claim 33 which further includes at least one mechanically balanced pick-up point located on the base.

35. A connector according to claim 33 or 34 wherein the first direction forms an included angle of between 5 and 175° with the second direction.

36. A connector according to claim 35 wherein the included angle is 45 to 95°.

37. A connector according to any one of claims 33 to 36 wherein the first direction is perpendicular to the second direction.

38. A connector according to claim 33 wherein the first direction forms an included angle of between 5 and 90° with the plane defined by the tabs of the base.

39. A connector according to claim 38 wherein the included angle is 90°.

40. A connector according to any one of claims 31 to 38 wherein the base of the angled connector is elongated or broadened relative to the first and second portions.

41. A connector according to any one of claims 31 to 40 having at least one tab adapted to promote capilliary action of the adhesive for adhering the connector to a circuit board.

42. A connector according to any one of claims 29 to 41 wherein the connector is manufactured in a strip of connectors, each connector being attached by a frangible means to the connectors on either side.

43. A connector according to any one of claims 29 to 41 wherein the connector is manufactured in a sheet of connectors, each connector having at least one frangible means attaching it to adjacent angled connectors.

44. A connector according to any one of claims 31 to 41 wherein the connector is sufficiently balanced that it can stand unaided on the one or more tabs

45. A method for mounting the connector of any one of claims 29 to 44 the method including the steps of;
(a) placing the connector in a predetermined position relative to a circuit board; and
(b) attaching the connector so that it is in electrical contact with the circuit board.

46. A method for mounting a connector according to any one of 29 to 44, the method including the steps of,
(a) attaching a pick-up device to a pick-up point of the connector,
(b) lifting the connector using the pick-up device,
(c) placing the one or more tabs of the connector into contact with adhesive means located on the circuit board,
(d) disengaging the pick-up device from the angled connector,
(e) heating the circuit board to liquify the adhesive means and allowing the angled connector to self centre, and subsequently
(f) allowing the adhesive means to re-solidify so that the tabs are held in electrical contact with the circuit board.

47. A method according to claim 46 wherein the connector is sufficiently balanced that it can stand unaided on the one or more tabs such that the disengagement step (d) can occur prior to steps (e) or (f).

48. A connector for mounting on a printed circuit board, the connector including one mechanically balanced pick-up point and wherein the connector is an angled connector.

49. A connector according to claim 48 having;
a contact, and
a base including one or more tabs defining a plane and suitable for attachment to a conductive surface of a printed circuit board.

50. A connector according to claim 49 which further includes,
a contact having,
(i) a first portion projecting from the base in a first direction and
(ii) a second portion projecting in a second direction from the first portion, the second portion being adapted to receive a connector or other device applied in a direction parallel to the second direction, the first direction differing from the second direction.

51. A connector according to claim 49 wherein the mechanically balanced pick-up point is located on the contact.

52. A connector according to claim 50 or 51 wherein the first direction forms an included angle of between 5 and 175° with the second direction.

53. A connector according to claim 52 wherein the included angle is 45 to 95°.

54. A connector according to any one of claims 50 to 53 wherein the first direction is perpendicular to the second direction.

55. A connector according to claim 54 wherein the first direction forms an included angle of between 5 and 90° with the plane defined by the tabs of the base.

56. A connector according to claim 55 wherein the included angle is 90°.

57. A connector according to any one of claims 50 to 56 wherein the base of the angled connector is elongated or broadened relative to the first and second portions.

58. A connector according to any one of claims 50 to 57 having at least one tab adapted to promote capillary action of the adhesive for adhering the connector to a circuit board.

59. A connector according to any one of claims 48 to 58 wherein the connector is manufactured in a strip of connectors, each connector being attached by a frangible means to the connectors on either side.

60. A connector according to any one of claims 48 to 58 wherein the connector is manufactured in a sheet of connectors, each connector having at least one frangible means attaching it to adjacent angled connectors.

61. A connector according to any one of claims 49 to 60 wherein the connector is sufficiently balanced that it can stand unaided on the one or more tabs

62. A method for mounting the connector of any one of claims 48 to 61 the method including the steps of;
(a) placing the connector in a predetermined position relative to a circuit board; and
(b) attaching the connector so that it is in electrical contact with the circuit board.

63. A method for mounting a connector according to any one of 49 to 61, the method including the steps of,
(a) attaching a pick-up device to a pick-up point of the connector,
(b) lifting the connector using the pick-up device,
(c) placing the one or more tabs of the connector into contact with adhesive means located on the circuit board,
(d) disengaging the pick-up device from the angled connector,
(e) heating the circuit board to liquify the adhesive means and allowing the angled connector to self centre, and subsequently
(f) allowing the adhesive means to re-solidify so that the tabs are held in electrical contact with the circuit board.

64. A method according to claim 63 wherein the connector is sufficiently balanced that it can stand unaided on the one or more tabs such that the disengagement step (d) can occur prior to steps (e) or (f).

65. A method for mounting a connector according to any one of claims 18, 19, 45, 46, 62 or 63 wherein loose connectors are fed into the pick-up device from a vibrating hopper.

66. A method for mounting a connector according to any one of claims 18, 19, 45, 46, 62 or 63 wherein a continuous strip of connectors is fed into the pick-up device.
